(19) United States
(12) Patent Application Publication
(10) Pub. No.: US 2021/0401667 A1
(43) Pub. Date: Dec. 30, 2021

(54) REFLEXOLOGY APPARATUS

(71) Applicant: Monique Rini, East Brunswick, NJ (US)

(72) Inventor: Monique Rini, East Brunswick, NJ (US)

(21) Appl. No.: 16/403,536

(22) Filed: May 4, 2019

Related U.S. Application Data
(60) Provisional application No. 62/667,407, filed on May 4, 2018.

(51) Int. Cl. A61H 39/04; G02C 11/00

(52) U.S. Cl. CPC A61H 39/04; A61H 2201/165; A61H 2201/1604; G02C 11/00

(57) ABSTRACT

A reflexology apparatus is described. In some examples, the reflexology apparatus can include a frame portion and one or more pressure point nodes attached to the frame portion. The reflexology apparatus can also include a removable sleeve portion that covers at least part of the frame portion and has one or more pressure point nodes attached to the removable sleeve portion.

### FIELD

Some implementations relate generally to an apparatus for creating adequate pressure or resistance against cranial, head and fascial pressure points, i.e., a reflexology apparatus.

### BACKGROUND

Reflexology is a therapeutic method of relieving pain and stress by stimulating predefined pressure points on the head, feet and hands. As reflexology considers the pressure points to be linked to other parts of the body, stimulating pressure points on the head, for example, can help address pain and stress in other parts of the body in certain situations and circumstances.

It may be desirable to provide an apparatus to form adequate pressure or resistance against cranial, head and fascial pressure points, thereby stimulating those pressure points. Some implementations were conceived in light of the above-mentioned needs, limitations, or problems, among other things.

### SUMMARY

Some implementations include a reflexology apparatus in the form of a wearable. Examples of wearables include eyewear, i.e., a frame of eye glasses or spectacles.

A reflexology apparatus comprises a frame portion and one or more pressure point nodes attached to the frame portion. The frame portion substantially conforms to at least part of an exterior profile of a wearable. The wearable can be, for example, a viewing apparatus such as eyewear. In some implementations, the frame portion and the pressure point nodes form a single integrated unit without one or more joints, interfaces, connections, or attachments.

The pressure point nodes are located on the frame portion such that the one or more pressure point nodes are adjacent to one or more pressure points on at least one of a head, face and cranium. The pressure point nodes can be made of plastic, metal, wood, stone, composite, synthetic, resin, rubber, foaming material, thermoplastic material, natural or man-made materials. The frame portion can be made of plastic, metal, wood, stone, composite, rubber, synthetic, thermoplastic material, textile material, foaming material, plant fibers, natural or man-made materials. The pressure point nodes can be attached to the frame portion using heat compression, hot melt adhesive film, glue or tenon joint structure among other ways.

Another reflexology apparatus comprises a removable sleeve portion and one or more pressure point nodes attached to the removable sleeve portion. The removable sleeve portion is configured to cover at least part of a frame portion. The frame portion substantially conforms to at least part of an exterior profile of a wearable. The wearable can be, for example, a viewing apparatus such as eyewear. In some implementations, the removable sleeve portion and the pressure point nodes form a single integrated unit without one or more joints, interfaces, connections, or attachments.

The pressure point nodes are located on the removable sleeve portion such that the one or more pressure point nodes are adjacent to one or more pressure points on at least one of a head, face and cranium. The pressure point nodes can be made of plastic, metal, wood, stone, composite, synthetic, resin, rubber, foaming material, thermoplastic material, natural or man-made materials. The removable sleeve portion can be made of plastic, metal, wood, composite, synthetic, leather, thermoplastic material, textile material, foaming material, plant fibers, natural or man-made materials. The pressure point nodes can be attached to the removable sleeve portion using heat compression, hot melt adhesive film, glue or tenon joint structure.

A method of making a reflexology apparatus by forming a removable sleeve portion to cover at least part of a frame portion and attaching pressure point nodes to the removable sleeve portion. In some implementations, forming of the removable sleeve portion and attaching of the pressure point nodes are implemented together as a single step. The pressure point nodes are located on the removable sleeve portion such that the one or more pressure point nodes are adjacent to one or more pressure points on at least one of a head, face or cranium.

### BRIEF DESCRIPTION OF THE DRAWINGS

FIG. 1 is a diagram showing right, rear and top perspective views of an example reflexology apparatus in accordance with some implementations.

FIG. 2 is a diagram showing right, rear and top perspective views of an example reflexology apparatus in accordance with some implementations.

FIG. 3 is a diagram showing front perspective views of a head with pressure points along with an example reflexology apparatus in accordance with some implementations.

FIG. 4 is a diagram showing side perspective views of a head with pressure points along with an example reflexology apparatus in accordance with some implementations.

### DETAILED DESCRIPTION

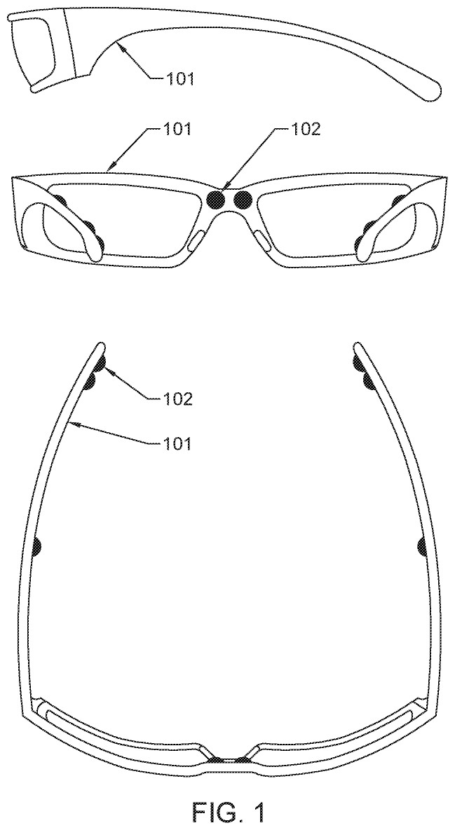

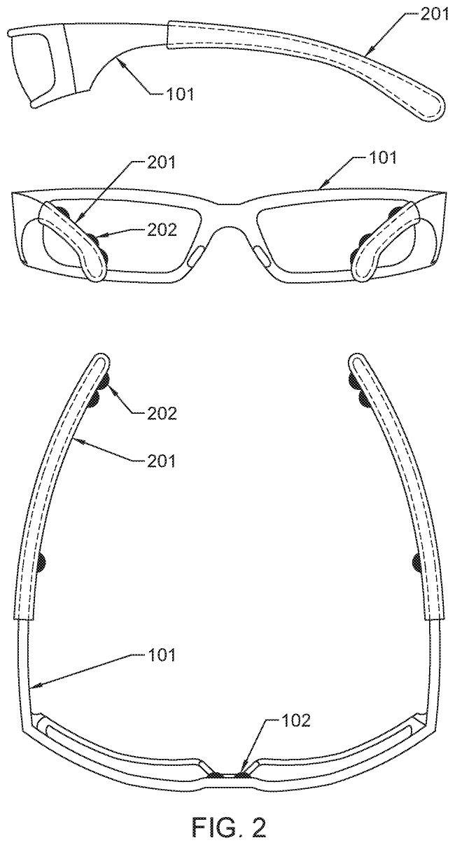

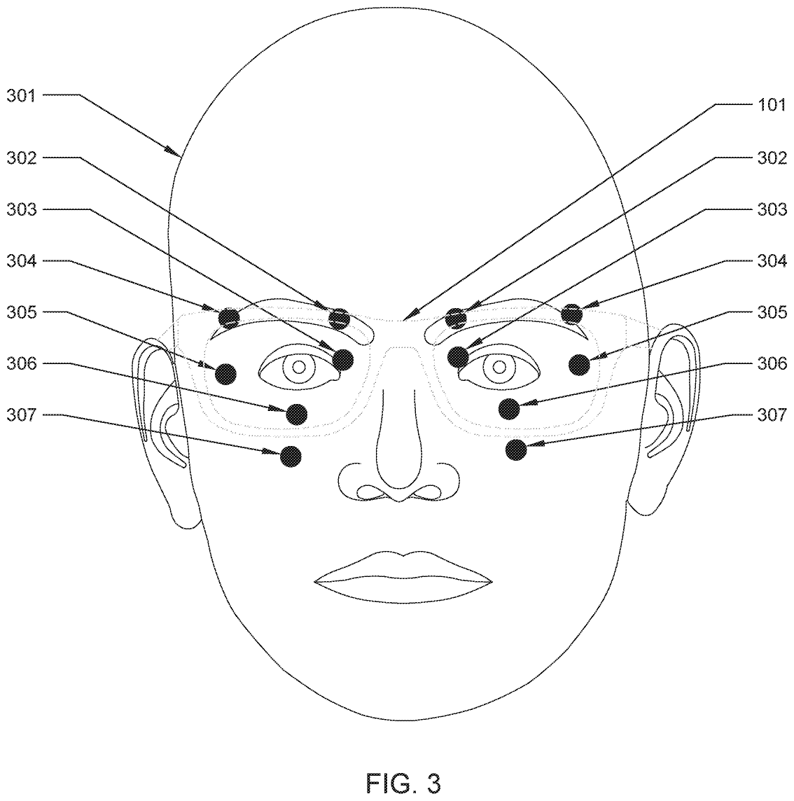

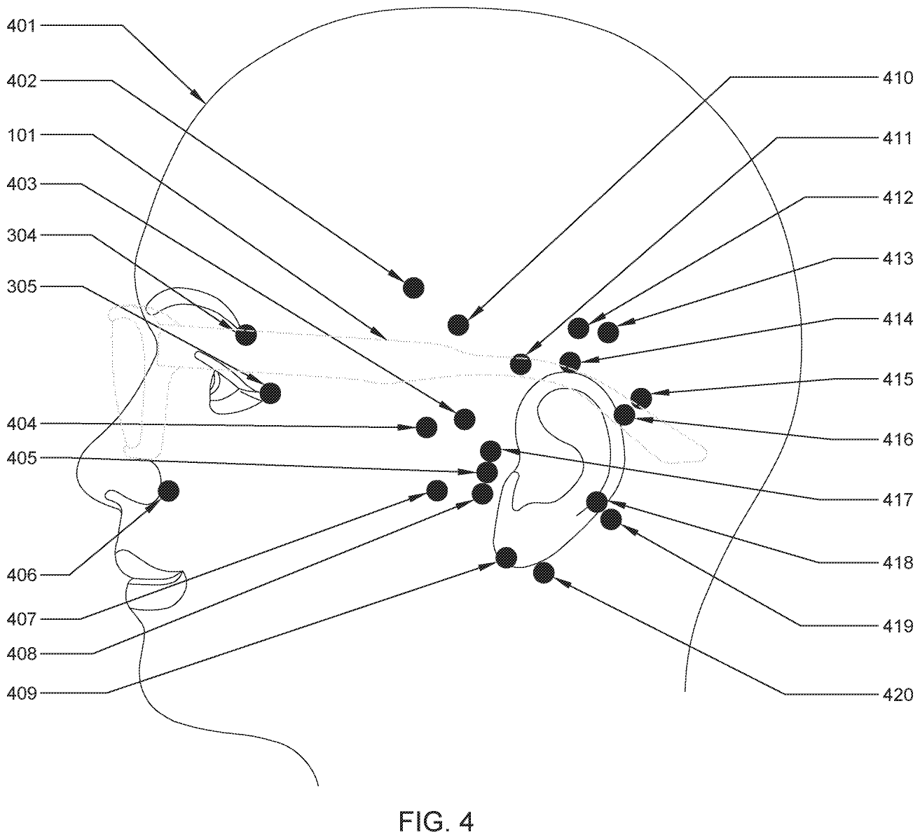

FIG. 1 and FIG. 2 show diagrams of an illustrative reflexology apparatus in the form of a frame of eyewear in FIG. 1 and a removable sleeve covering at least part of a frame of eyewear in FIG. 2. FIG. 3 and FIG. 4 indicate potential cranial, head and fascial pressure points on which the reflexology apparatus can act upon.

FIG. 1 illustrates a reflexology apparatus that substantially conforms to an exterior profile of an eyewear. The eyewear has a frame portion 101 and pressure point nodes, pods, bumps or bubbles 102 that can be in a variety of patterns, diameters, heights, shapes and compositions. The pressure point nodes 102 are attached to the frame portion 101 using one or more of heat compression, hot melt adhesive film, glue and tenon joint structure, among other ways. The pressure point nodes 102 are located on the frame portion such that one or more of the pressure point nodes create adequate pressure or resistance against cranial, head and fascial pressure points. In other implementations, the frame portion of the reflexology apparatus can substantially conform to an exterior profile of a variety of wearables in different shapes, forms and sizes.

In FIG. 2, the pressure point nodes, pods, bumps or bubbles 202 are connected to an illustrative removable sleeve portion 201. The pressure point nodes, pods, bumps or bubbles 202 can be in a variety of patterns, diameters, heights, shapes and compositions. The pressure point nodes 202 can be connected to the removable sleeve portion 201 using one or more of heat compression, hot melt adhesive film, glue and tenon joint structure, among other ways. The removable sleeve portion 201 covers at least part of an illustrative frame portion 101 in FIG. 2. The removable sleeve portion 201 can be configured to cover and conform to different frame portions based on the size, pattern, diameter, and/or shape of the respective frame portions.

It will be appreciated that the frame portion and the removable sleeve portion described herein are for illustration purposes only and are not intended to be limiting. Other frame portions and/or removable sleeve portions can be used depending on a contemplated implementation. The frame portions and/or removable sleeve portions can be made in a variety of patterns, diameters, heights, shapes and compositions. A frame portion can, for example, correspond to the exterior profile of a wearable such as eyewear other such viewing apparatus. It will be appreciated that the pressure point nodes described herein are for illustration purposes only and are not intended to be limiting. Other pressure point nodes such as pods, bumps or bubbles, among others, can be used depending on a contemplated implementation. Also, in some implementations, the frame portion and the pressure point nodes form a single integrated unit without one or more joints, interfaces, connections, or attachments. In some other implementations, the removable sleeve portion and the pressure point nodes form a single integrated unit without one or more joints, interfaces, connections, or attachments.

FIG. 3 illustrates a front view of a superimposed head 301 with illustrative pressure points 302 to 307. 302 illustrates pressure point location B2 Gallbladder Meridian and applying pressure to 302 can help address issues such as tired and aching eyes, visual defects, blurred vision, reddened eyes, itchy eyes, frontal headaches, dizziness, coryza, nasal congestion, sinusitis, nose bleeds, facial nerve paralysis, lack of concentration, and epilepsy among other conditions. 303 illustrates pressure point location B1 Gallbladder Meridian and applying pressure to 303 can help address issues such as far-sightedness, night-blindness, red eyes, optic neuritis, retinitis, cataracts, migraines, frontal headaches, insomnia, and nasal congestion among other conditions.

304 illustrates pressure point location TW23 Triple Warmer Meridian and applying pressure to 304 can help address issues such as headaches, migraines, amblyopia, red eyes, coryza, ringing in the ears, hearing loss, dizziness, unrest, irritability, aggressiveness, vertigo, shivering, toothache, facial twitches, epilepsy, and hair loss among other conditions. 305 illustrates pressure point location G1 Gallbladder Meridian and applying pressure to 305 can help address issues such as visual defects, myopia and hyperopia, night-blindness, cataracts, conjunctivitis, temporal headaches, and migraines among other conditions.

306 illustrates pressure point location ST1 Stomach Meridian and applying pressure to 306 can help address issues such as myopia, hyperopia, color blindness, night-blindness and other eye disorders, all types of vision problems, conjunctivitis, inflammation and atrophy of the optic nerve, unilateral paralysis of the face, twitching of the facial muscles, and ringing in the ears among other conditions. 307 illustrates pressure point location ST2 Stomach Meridian and applying pressure to 307 can help address issues such as eye tension, myopia, painful and reddened eyes, itchy eyes, conjunctivitis, nasal congestion, nervous tension, paralysis, trigeminal neuralgia, headaches, and vertigo among other conditions.

FIG. 4 illustrates a side view of a superimposed head 401 with illustrative pressure points 402 to 420. 402 illustrates pressure point location G5 Gallbladder Meridian and applying pressure to 402 can help address issues such as colds, one-sided headaches, migraines, tooth ache and jaw pain, eye pain, reddened eyes, and ametropia among other conditions. 403 illustrates pressure point location TW22 Triple Warmer Meridian and applying pressure to can help address issues such as all sorts of headaches, coryza, fears, twitching and spasms of mouth, eyelids and eyes, spasm of the jaw muscles, ringing in the ears, and swelling of the nose or throat among other conditions. 404 illustrates pressure point location G3 Gallbladder Triple Warmer Meridian and applying pressure to 404 strengthens eyesight can help address issues such as impaired vision, dizziness, temporal headaches, tired eyes, shivers, excessive menstrual bleeding, toothache, ringing in the ears, hardness of hearing, deafness, unilateral headaches, facial nerve paralysis, and epilepsy, among other conditions.

405 illustrates pressure point location Si19 Small Intestine Meridian and applying pressure to 405 can help address issues such as ear ailments, decreasing hearing and vision, ringing in the ears, hardness of hearing, deafness, earache, ear infection, facial nerve disorders, and toothache among other conditions. 406 illustrates pressure point location Li20 Large Intestine Meridian and applying pressure to 406 can help address issues such as nasal diseases, coryza, cold (runny or stuffy nose), hay fever, nosebleeds, loss of smell, maxillary dental pain, pyorrhea, facial skin complaints with itching, complaints regarding facial muscles, difficulty in breathing, and asthma among other conditions. 407 illustrates pressure point location ST7 Stomach Meridian and applying pressure to 407 can help address issues such as ear complaints, hardness of hearing, ringing in the ears, toothache, gingival swelling, repressed aggression, nocturnal tooth grinding, dislocation of the temporomandibular joint, and trigeminal neuralgia among other conditions.

408 illustrates pressure point location G2 Gallbladder Meridian and applying pressure to 408 lightens mood and can help address issues such as depressive disorders, ear ailments of all kinds, toothache, cramps, facial nerve paralysis, and trigeminal neuralgia among other conditions. 409 illustrates pressure point location TW17 Triple Warmer Meridian and applying pressure to 409 can help address issues such as dizziness, ear symptoms, ringing in the ears, hardness of hearing, hearing loss, hiccoughs, neck complaints, toothache, pharyngitis, mumps, trigeminal neuralgia, and facial nerve paralysis among other conditions. 410 illustrates pressure point location G6 Gallbladder Meridian and applying pressure to 410 can help address issues such as unilateral headaches, cold, flu, toothache, burping, nausea, fever, erythematous, swollen face, tremors and twitching among other conditions.

411 illustrates pressure point location G7 Gallbladder Meridian and applying pressure to 411 can help address issues such as temporal headaches, one-sided headaches, toothache, jaw pain, stiff neck, blurred vision, nausea, and vomiting among other conditions. 412 illustrates pressure point location G8 Gallbladder Meridian and applying pressure to 412 can help address issues such as temporal headaches, eye problems, migraines, ringing in the ears, dizziness, indigestion, nausea, and vomiting, among other conditions. 413 illustrates pressure point location G9 Gallbladder Meridian and applying pressure to 413 can help address issues such as temporal headaches, depression, despair, jumpiness, speech disorders, cramps, epilepsy-like symptoms, and swelling of the gums among other conditions.

414 illustrates pressure point location TW20 Triple Warmer Meridian and applying pressure to 414 can help address issues such as headaches, stiff neck, ear symptoms, ringing in the ears, amblyopia, blurred vision, reddened eyes, toothache, gingivitis, conjunctivitis, swollen cheeks, and numbness of the lips among other conditions. 415 illustrates pressure point location G10 Gallbladder Meridian and applying pressure to 415 can help address issues such as headaches, toothache, heavy head, eye disorders, ringing in the ears, neck swelling, thyroid enlargement, shoulder, back and chest pain, and oppressed breathing among other conditions. 416 illustrates pressure point location TW19 Triple Warmer Meridian and applying pressure to 416 can help address issues such as ear complaints, ringing in the ears, blurred vision, headaches, cramps, convulsions, and chest pain among other conditions.

417 illustrates pressure point location TW21 Triple Warmer Meridian and applying pressure to 417 can help address issues such as headaches, ear symptoms, ringing in the ears, amblyopia, blurred vision, toothaches, gingivitis, conjunctivitis, muscle twitching in the face, and migraines, among other conditions. 418 illustrates pressure point location TW18 Triple Warmer Meridian and applying pressure to 418 can help address issues such as headaches, ringing in the ears, hardness of hearing, blurred vision, failing eyesight, anxiety, lack of self-enforcing, nausea, and vomiting, among other conditions. 419 illustrates pressure point location G11 Gallbladder Meridian and applying pressure to 419 can help address issues such as insomnia, flank pain, ringing in the ears, hardness of hearing, deafness, eye pain, leg cramps, neck and cheek swelling, bleeding in the mouth, bitter taste in the mouth, and mumps among other conditions. 420 illustrates pressure point location G12 Gallbladder Meridian and applying pressure to 420 can help address issues such as insomnia, head and neck pain, migraines, puffiness, neck swelling, stiff neck, dysphagia, toothache, lockjaw, hemiplegia, epilepsy-like seizures, and reddish dark urine among other conditions.

The frame portion 101 can be made of a variety of materials, including, for example, plastic, metal, wood, stone, composite, rubber, synthetic, thermoplastic material, textile material, foaming material, plant fibers, natural and man-made materials. The pressure point node portions 102 and 202 can be made of a variety of materials, including, for example, plastic, metal, wood, stone, composite, synthetic, resin, rubber, foaming material, thermoplastic material, natural and man-made materials. The removable sleeve portion 201 can be made of a variety of materials, including, for example, plastic, metal, wood, composite, synthetic, leather, thermoplastic material, textile material, foaming material, plant fibers, natural and man-made materials.

In some implementations, the pressure point nodes can be instrumented with sensors and associated electronics to measure pressure in one or more locations for evaluating the efficacy of the therapy with the reflexology apparatus. Data corresponding to the measured pressure or other sensed parameters can be stored or transmitted. The associated electronics can include, for example, microcontrollers, flash memory devices, wired or wireless data communication interfaces, and power sources (such as batteries, kinetic power generators, etc.).

The reflexology apparatus can include formed pressure pods, especially in combination with a series of pods. These pods can be of various geometric configurations, from simple semi spheres to semi oblique spheroids, and can have transfer functions describing natural curvature, such as the Fibonacci spiral segments. In some implementations, these pods can be active, wherein the active members can be spring loaded with elements that compress and then expand swiftly to cause a massaging element. In other implementations, these pods can be static.

In some implementations, the reflexology apparatus may comprise radio frequency emitting elements, heating elements, infrared heating elements, vibration elements, cooling elements, plant-derived oils and/or dried plant products to deliver comfort, disinfectant and/or therapeutic benefits of aromatherapy through direct contact with the user's face, head, ears, eyes and nose. For instance, these features can be applied to or constructed within the eyewear frame or the removable sleeve portion. The eyewear frame can have a built-in aromatherapy component that is distributed from strategically placed perforations on the frame. The eyewear frame and/or the removable sleeve can have components to absorb and/or deliver essential oils, plant-derived essential oils and/or other plant-derived products. In some implementations, such components can be porous in form.

It is therefore apparent that there is provided, in accordance with the various example implementations disclosed herein, a reflexology apparatus. While the disclosed subject matter has been described in conjunction with a number of implementations, it is evident that many alternatives, modifications and variations would be or are apparent to those of ordinary skill in the applicable arts. Accordingly, Applicant intends to embrace all such alternatives, modifications, equivalents and variations that are within the spirit and scope of the disclosed subject matter.

What is claimed is:

1. A reflexology apparatus comprising:
a frame portion; and
one or more pressure point nodes attached to the frame portion.

2. The reflexology apparatus of claim 1, wherein the frame portion substantially conforms to at least part of an exterior profile of a wearable.

3. The reflexology apparatus of claim 2, wherein the wearable is a viewing apparatus.

4. The reflexology apparatus of claim 3, wherein the viewing apparatus is eyewear.

5. The reflexology apparatus of claim 1, wherein the pressure point nodes are located on the frame portion such that the one or more pressure point nodes are adjacent to one or more pressure points on at least one of a head, face or cranium.

6. The reflexology apparatus of claim 1, wherein the frame portion is made of at least one of plastic, metal, wood, stone, textile, rubber, plant fiber, foaming, thermoplastic, composite, synthetic, natural or man-made materials.

7. The reflexology apparatus of claim 1, wherein the pressure point nodes are made of at least one of plastic, metal, wood, stone, resin, rubber, foaming, thermoplastic, composite, synthetic, natural or man-made materials.

8. The reflexology apparatus of claim 1, wherein the pressure point nodes are attached to the frame portion using at least one or more of heat compression, hot melt adhesive film, glue or tenon joint structure.

9. The reflexology apparatus of claim 1, wherein the frame portion and the pressure point nodes form a single integrated unit without one or more joints, interfaces, connections, or attachments.

10. A reflexology apparatus comprising:
a removable sleeve portion that covers at least part of a frame portion; and
at least one or more pressure point nodes attached to the removable sleeve portion.

11. The reflexology apparatus of claim 10, wherein the frame portion substantially conforms to at least part of an exterior profile of a wearable.

12. The reflexology apparatus of claim 11, wherein the wearable is a viewing apparatus.

13. The reflexology apparatus of claim 12, wherein the viewing apparatus is eyewear.

14. The reflexology apparatus of claim 10, wherein the pressure point nodes are located on the removable sleeve portion such that the one or more pressure point nodes are adjacent to one or more pressure points on at least one of a head, face and cranium.

15. The reflexology apparatus of claim 10, wherein the removable sleeve portion is made of at least one of plastic, metal, wood, leather, textile, plant fiber, foaming, thermoplastic, composite, synthetic, natural or man-made materials.

16. The reflexology apparatus of claim 10, wherein the pressure point nodes are made of at least one of plastic, metal, wood, stone, resin, rubber, foaming, thermoplastic, composite, synthetic, natural or man-made materials.

17. The reflexology apparatus of claim 10, wherein the pressure point nodes are attached to the removable sleeve portion using at least one or more of heat compression, hot melt adhesive film, glue and tenon joint structure.

18. The reflexology apparatus of claim 10, wherein the removable sleeve portion and the pressure point nodes form a single integrated unit without one or more joints, interfaces, connections, or attachments.

19. A method for making a reflexology apparatus, the method comprising:
forming a removable sleeve portion to cover at least part of a frame portion; and
attaching one or more pressure point nodes to the removable sleeve portion.

20. The method of claim 19, wherein the one or more pressure point nodes are located on the removable sleeve portion such that the one or more pressure point nodes are adjacent to one or more pressure points on at least one of a head, face or cranium.

21. The method of claim 19, wherein forming the removable sleeve portion and attaching the pressure point nodes to the removable sleeve portion constitute a single step.
